(19) United States
(12) Patent Application Publication
(10) Pub. No.: US 2021/0206079 A1
(43) Pub. Date: Jul. 8, 2021

(54) ADDITIVE MANUFACTURING MACHINE OPTICAL FILTER

(71) Applicant: HEWLETT-PACKARD DEVELOPMENT COMPANY, L.P., Spring, TX (US)

(72) Inventor: Arthur H BARNES, Vancouver, WA (US)

(73) Assignee: HEWLETT-PACKARD DEVELOPMENT COMPANY, L.P., Houston, TX (US)

(21) Appl. No.: 16/075,635

(22) PCT Filed: Apr. 25, 2017
(86) PCT No.: PCT/US2017/029346

§ 371 Date: Aug. 4, 2018

(51) Int. Cl. B29C 64/286; B29C 64/153

(52) U.S. Cl. CPC B29C 64/286; B29C 64/295; B29C 64/153

(57) ABSTRACT

Some examples include a fusing apparatus for an additive manufacturing machine including an enclosure defining a cavity, the enclosure including an open side portion to be oriented toward a build zone, a thermic source housed in the cavity, the thermic source emitting a first emission spectrum, and an optical filter disposed across the open side portion between the thermic source and the build zone, the optical filter having a microstructure refined major surface to filter the first emission spectrum to a second emission spectrum.

### BACKGROUND

Additive manufacturing machines produce 3D objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices each defining that part of a layer or layers of build material to be formed into the object.

### BRIEF DESCRIPTION OF THE DRAWINGS

FIG. 1 is a schematic side view of an example fusing apparatus for an additive manufacturing machine in accordance with aspects of the present disclosure.

FIGS. 2A and 2B are schematic side and top views of an optical filter useful in the fusing apparatus for an additive manufacturing machine in accordance with aspects of the present disclosure.

FIG. 3 is a flow chart of an example method of operating a fusing apparatus of an additive manufacturing machine in accordance with aspects of the present disclosure.

FIG. 4 is a schematic side view of an additive manufacturing machine in accordance with aspects of the present disclosure.

FIGS. 5A-8B are side and top schematic views illustrating a sequence of an example four pass fusing cycle using a fusing system of an additive manufacturing machine in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some additive manufacturing processes, thermic energy is used to fuse together the particles in a powdered build material to form a solid object. Thermic energy to fuse the build material may be generated, for example, by applying a liquid fusing agent to a thin layer of powdered build material in a pattern based on the object slice and then exposing the patterned area to fusing energy. Fusing energy absorbing components in the fusing agent absorb fusing energy to help sinter, melt or otherwise fuse the build material. The process is repeated layer by layer and slice by slice to complete the object.

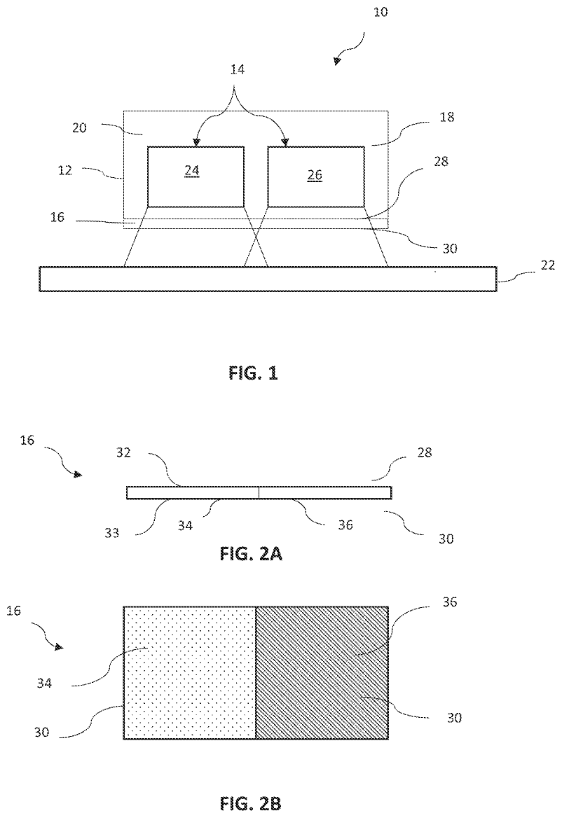

FIG. 1 is a schematic side view of an example fusing apparatus 10 for an additive manufacturing machine in accordance with aspects of the present disclosure. Fusing apparatus 10 includes an enclosure 12, a thermic source 14, and an optical filter 16. Enclosure 12 defines a cavity 18 and includes an open side portion 20 to be oriented toward a build zone 22. Thermic source 12 is housed in cavity 18. Optical filter 16 is disposed across open side portion 20 between thermic source 14 and build zone 22. Thermic source 14 can emit a first emission spectrum, as described further below.

Thermic source 14 can be sealably contained by enclosure 12 and optical filter 16. In one example, enclosure 12 and optical filter 16 maintain cavity 18, containing thermic source 14, at a negative pressure. Thermic source 14 is a black body radiator that emits thermal radiation. With respect to thermic source 14 of fusing system 10, thermic source 14 can include any suitable number and type of thermic sources to heat and irradiate a build material. Thermic source 14 including lower color temperature warming lamps and higher color temperature fusing lamps can provide control for heating and fusing of a build material. Thermic source 14 can include warming and fusing sources 24, 26. Thermic source 14 emits a spectrum of radiated wavelengths. Fusing source 26 and warming source 24 can have differing emission spectrums. Fusing source 26 can include more near-infrared (IR) content, or wavelengths, than warming source 24. Warming source 24 can include more mid-IR wavelength. In one example, fusing source 26 primarily includes IR wavelengths of 0.75 to 1.5 micrometre (μm). In one example, warming source 24 primarily includes IR wavelengths of 1.5 to 4.0 micro-meters (μm).

Fusing source 26 can be of higher color temperature to sufficiently heat fusing agent 72 and build material to selectively fuse build the build material 70. Warming source 24 can be of lower color temperature to selectively heat the build material without causing build material to fuse. In one example, fusing source 26 has a 2750 degree Kelvin color temperature. Fusing source 26 can include a series of thermal lamps each being longitudinally arranged in parallel with major axes disposed along the y-axis. In one example, warming source 24 has an 1800 degree Kelvin color temperature. Other color temperatures can also be suitable. A single or multiple warming and fusing sources 24, 26 can be included. Fusing lamp 24 is to irradiate build material with fusing energy. In general, warming and fusing sources 24, 26 each include lamps. Fusing source 26 can include any suitable number and type of lamps to heat and irradiate build material. For example, each of the warming and fusing sources 24, 26 includes quartz infrared halogen lamps with each of the quartz infrared halogen lamps having a segmented filament. Fusing source 26 can include a series of thermal lamps each being longitudinally arranged in parallel with major axes disposed along the y-axis. Similarly, warming source 24 can include a series of thermal lamps each being longitudinally arranged in parallel with major axes disposed along the y-axis.

FIGS. 2A and 2B are schematic side and top views of optical filter 16 useful in fusing apparatus 10 for an additive manufacturing machine in accordance with aspects of the present disclosure. Optical filter 16 includes a first major surface 28 and a second major surface 30 opposing the first major surface. Optical filter 16 is disposed in enclosure 12 such that one of first or second major surface 28, 30 is positioned toward cavity 18. Optical filter 16 can be formed of a glass, such as borofloat®, for example.

First major surface 28 of optical filter 16 can have a microstructure refined major surface 32 to filter, or modify, the emission spectrum of thermic source 14 from a first emission spectrum to a second emission spectrum. Second major surface 30 of optical filter 16 can have a microstructure refined major surface 33 to filter, or modify, the emission spectrum of thermic source 14 from a first emission spectrum to a second emission spectrum. An entirety, or only a portion of, first and/or second major surfaces 28, 30 can include microstructure refined major surfaces 32, 33. Microstructure refined major surfaces 32, 33 can be structured to either absorb or reflect selective wavelengths, to suppress the passage of the select wavelengths through optical filter 16 as described further below. Microstructure refined major surfaces 32, 33 can be employed with thermal source 14 to aid in independently controlling the warming and the fusing of build material during the build process of three dimensional objects.

In one example, microstructure refined major surface 32 includes a first surface area 34 and a second surface area 36. First and second surface areas 34, 36 can be independently, or differently, microstructured for independent filtering properties of reflecting or absorbing select wavelengths within the emission spectrum emitted by thermic source 14. For example, first surface area 34 can selectively filter the emission spectrum emitted by thermal source 14 into a second emission spectrum and second surface area 36 can selectively filter the emission spectrum emitted by thermal source 14 into a third emission spectrum. In one example, thermal source 14 includes warming and fusing sources 24, 26 and first and second surface areas 34, 36 are disposed between warming and fusing sources 24, 26 and build zone 22, respectively, for independent filtering of warming and fusing sources 24, 26. In one example, second surface area 36 provides short wave pass filtering and is disposed between fusing source 26 and build zone 22, and first surface area 34 provides long wave pass filtering and is disposed between warming source 24 and build zone 22. Short wave pass filtering provides that wavelengths lower a cut-off wavelength (e.g., 1.5 μm) are allowed to transmit through optical filter 16 while wavelength higher than the cut-off wavelength (e.g., 1.5 μm) are blocked by optical filter 16 either by absorption or reflection. Conversely, long wave pass filtering provides that wavelengths higher a cut-off wavelength (e.g., 1.5 μm) are allowed to transmit through optical filter 16 while wavelength lower than the cut-off wavelength (e.g., 1.5 μm) are blocked by optical filter 16, either by absorption or reflection.

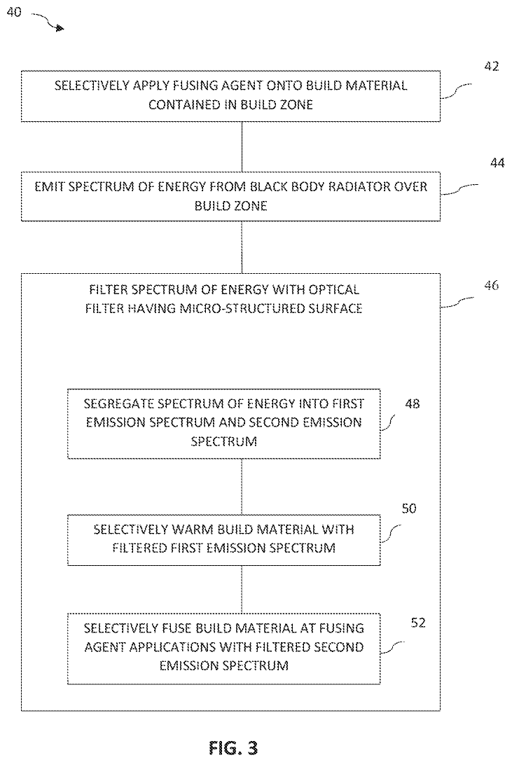

FIG. 3 is a flow chart of an example method 40 of operating a fusing apparatus of an additive manufacturing machine in accordance with aspects of the present disclosure. At 42, a fusing agent is selectively applied onto a build material contained in a build zone. At 44, a spectrum of energy is emitted from a black body radiator over the build zone. At 46, the spectrum of energy is filtered with an optical filter having a micro-structured surface. At 48, the filtering is to segregate the spectrum of energy into a first emission spectrum and a second emission spectrum. At 50, the filtering is to selectively warm the build material with the filtered first emission spectrum. At 52, the filtering is to selectively fuse the build material at the fusing agent applications with the filtered second emission spectrum.

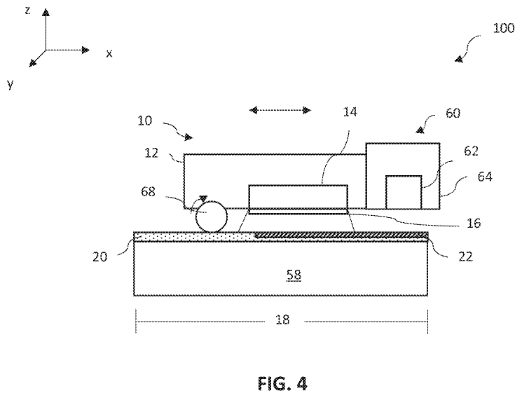

FIG. 4 illustrates one example of additive manufacturing machine 100 including fusing system 10. In addition to fusing system, or assembly, 10, additive manufacturing machine 100 includes a dispensing assembly 60 movable over a build chamber 58. Fusing system 10 and dispensing assembly 60 are movable along the x-axis over build chamber 58. Dispensing assembly 60 includes a printhead 62 (or other suitable liquid dispensing assemblies) mounted to a dispensing carriage 64 to selectively dispense fusing agent 72 and other liquid agents, if used. Build chamber 58 can contain build material 70 and fusing agent 72 as layers are formed. Build chamber 58 can be any suitable structure to support or contain build material 70 in build zone 18 for fusing, including underlying layers of build material 70 and in-process slice and other object structures. For a first layer of build material 70, for example, build chamber 58 can include a surface of a platform that can be moved vertically along the y-axis to accommodate the layering process. For succeeding layers of build material 70, build zone 18 can be formed on an underlying build structure within build chamber 58 including unfused and fused build material forming an object slice. Controller 16 can control energy levels, as discussed further below. Controller 16 can also control other functions and operations of additive manufacturing machine 100.

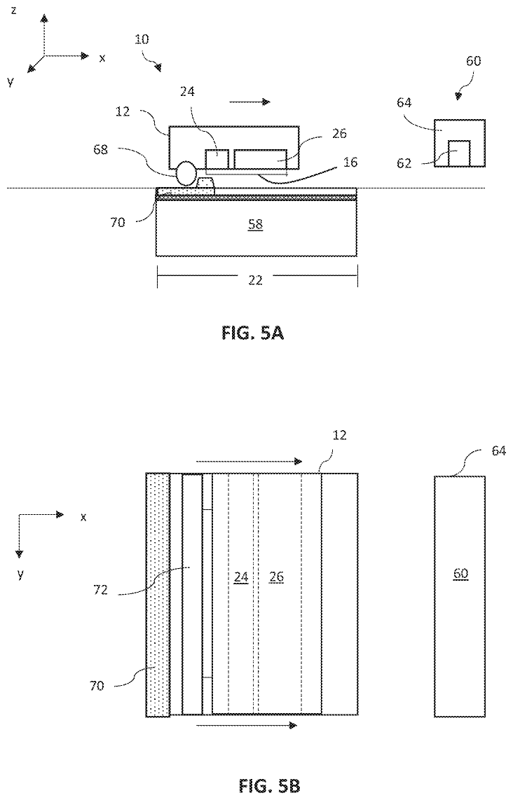

FIGS. 5A-8B are side and top schematic views illustrating an example sequence of a four pass fusing cycle using a fusing system of an additive manufacturing machine. Each pass includes multiple operations that can occur simultaneously during the respective pass. Fusing system 10 and dispensing assembly 60 move bi-directionally over build zone 18 within build chamber 58 along the same line of motion so that carriages 12, 64 can follow each other across build zone 18. A dual carriage fusing system in which carriages 12, 64 move along the same line of motion helps enable faster slew speeds and overlapping functions in each pass. In accordance with one example, direction of movement of the passes, is indicated by arrows in FIGS. 5A-8B. Carriages 12, 64 of fusing system 10 and dispensing assembly 60 move completely and entirely across build zone 18 and can be positioned on either side of build zone 18. In general, a roller 68 can be included on fuser carriage 12 to spread build material 70 to form layers over build zone 18. Dispenser carriage 64 carries the agent dispenser 62 to dispense fusing agent 72 on to each layer of build material 70. Thermic source 14 carried by carriage 12 heats and irradiates layered build material 70 and fusing agent 72.

With respect to thermic source 14 of fusing system 10, thermic source 14 can include any suitable number and type of thermic sources to heat and irradiate build material. Thermic source 14 including lower color temperature warming lamps and higher color temperature fusing lamps can provide control for heating and fusing of build material. Thermic source 14 illustrated in FIGS. 5A-8B include warming and fusing sources 24, 26. Fusing source 26 can be of higher color temperature to sufficiently heat fusing agent 72 and build material 70 to selectively fuse build the build material 70. Warming source 24 can be of lower color temperature to selectively heat the build material 70 without causing fuse build. In one example, fusing source 26 has a 2750 degree Kelvin color temperature. Fusing source 26 can include a series of thermal lamps each being longitudinally arranged in parallel with major axes disposed along the y-axis. In one example, warming source 24 has an 1800 degree Kelvin color temperature. Other color temperatures can also be suitable. A single or multiple warming and fusing sources 24, 26 can be included. Fusing lamp 24 is to irradiate build material 70 with fusing energy.

With reference to FIGS. 5A and 5B, in a first pass of the example sequence, as fuser carriage 12 begins at left of build zone 18 and moves across build zone 18 toward right side of build zone 18. Warming lamp 24 is powered on to heat the underlying layer/slice in front of roller 68 as roller 68 passed across build zone 18 to form a first, or next, layer of build material 70. Roller 68 is positioned to contact build material 70 during the first spreading pass. Thermic energy from warming source 24 is reflected from previous layers of build material 70 to uniformly heat build zone. After first pass has been completed, fuser carriage 12 is positioned to right side of build zone 18 and prepares for a second spreading pass.

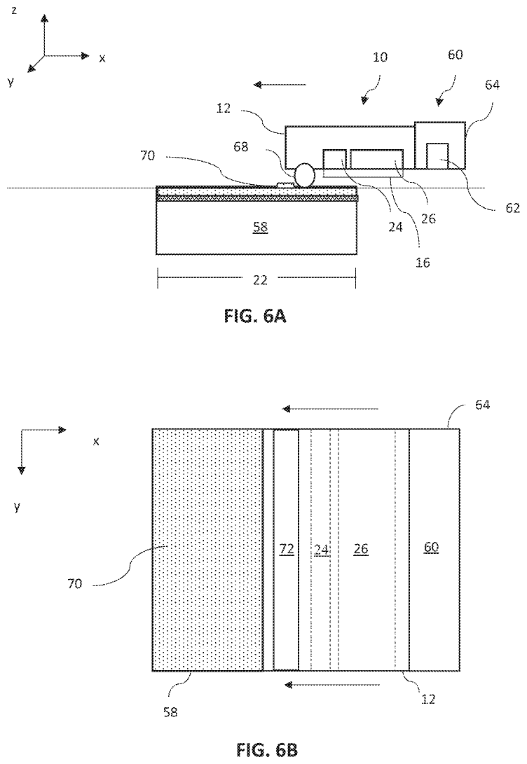

Second pass is illustrated in FIGS. 6A and 6B. In second pass, as fuser carriage 12 moves back over build zone 18 from the right to the left, warming source 24 is on to heat the new layer of build material 70 in advance of dispenser carriage 64, which follows fuser carriage 12 over build zone 18 to dispense fusing and/or detailing agents on to the heated build material 70 in a pattern based on a next object slice. Roller 68 can complete spreading build material 70 that may not be completely spread during first pass, in advance of warming lamp 24 and dispenser carriage 64.

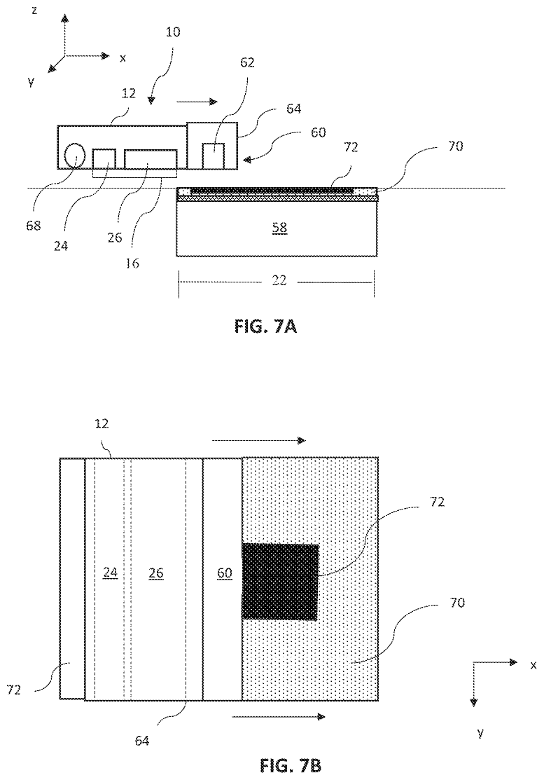

Third pass is illustrated in FIGS. 7A and 7B. Third pass is a fusing pass. In third pass, dispenser carriage 64 moves back over build zone 18, from left to right, to dispense fusing and/or detailing agents 22 on to build material 70, followed by fuser carriage 12 with fusing source 26 on to expose patterned build material to fusing energy.

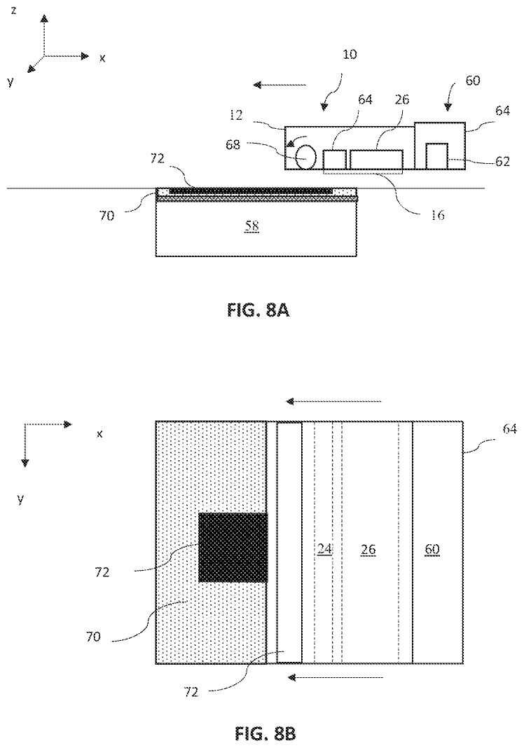

In fourth pass, as illustrated in FIGS. 8A and 8B, as fuser carriage 12 moves back over build zone 18, from right to left, and fusing source 26 is on to expose patterned build material to fusing energy. The four pass process may be repeated for successive layers of build material as the object is manufactured layer by layer and slice by slice.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A fusing apparatus for an additive manufacturing machine, comprising:
an enclosure defining a cavity, the enclosure including an open side portion to be oriented toward a build zone;
a thermic source housed in the cavity, the thermic source to emit a first emission spectrum; and
an optical filter disposed across the open side portion between the thermic source and the build zone, the optical filter having a microstructure refined major surface to filter the first emission spectrum to a second emission spectrum.

2. The fusing apparatus of claim 1, wherein the microstructure refined major surface includes a first surface area and a second surface area, the first surface area to selectively filter the first emission spectrum to the second emission spectrum and the second surface area to filter the first emission spectrum to a third emission spectrum.

3. The fusing apparatus of claim 1, the optical filter includes an opposing microstructure refined major surface opposite the microstructure refined major surface.

4. The fusing apparatus of claim 1, wherein the thermic source includes a warming source and a fusing source, the warming source to emit the first emission spectrum and the fusing source to emit a third emission spectrum.

5. The fusing apparatus of claim 4, wherein the optical filter is to filter the third emission spectrum to a fourth emission spectrum.

6. The fusing apparatus of claim 1, wherein the thermic source is sealably contained by the enclosure and the optical filter.

7. A method of operating an additive manufacturing machine comprising:
selectively applying a fusing agent onto a build material contained in a build zone;
emitting a spectrum of energy from a black body radiator over the build zone; and
filtering the spectrum of energy with an optical filter having a micro-structured surface, the filtering to:
segregate the spectrum of energy into a first emission spectrum and a second emission spectrum,
selectively warm the build material with the filtered first emission spectrum, and
selectively fuse the build material at the fusing agent applications with the filtered second emission spectrum.

8. The method of claim 7, wherein the filtering suppresses select wavelengths of the spectrum of energy.

9. The method of claim 7, wherein the filtered first emission spectrum suppresses infrared energy of 0.75 to 1.5 micrometres.

10. The method of claim 7, wherein the filtered second emission spectrum suppresses infrared energy of 1.5 to 4.0 micrometres.

11. The method of claim 7, wherein the filtering to the filtered second emission spectrum rejects wavelengths within the spectrum of energy.

12. A fusing apparatus for an additive manufacturing machine, comprising:
an enclosure defining a cavity, the enclosure including an open side portion to be oriented toward a build zone;
a black body radiator to produce a thermic energy, the black body radiator mounted within the enclosure; and
a optical filter having a micro-structured surface disposed between the black body radiator and the build zone, the optical filter to modify the thermic energy passing through the optical filter to the build zone.

13. The fusing apparatus of claim 12, wherein the black body radiator is a quartz infrared halogen lamp.

14. The fusing apparatus of claim 12, wherein the black body radiator includes a warming lamp to selectively warm a build material within the build zone, and a fusing lamp to selectively fuse the build material at a fusing agent within the build zone.

15. The fusing apparatus of claim 14, wherein the optical filter includes:
a short wave pass filter disposed between the fusing lamp and the build zone, and
a long wave pass filter disposed between the warming lamp and the build zone.
